(19) United States
(12) Patent Application Publication
(10) Pub. No.: US 2003/0155875 A1
(43) Pub. Date: Aug. 21, 2003

(54) Circuit arrangement for the actuation of an electric-motor drive, in particular a pump drive, in a large domestic appliance

(75) Inventor: Martin Weinmann, Bad Waldsee (DE)

Correspondence Address: Leopold Presser, SCULLY, SCOTT, MURPHY & PRESSER, 400 Garden City Plaza, Garden City, NY, 11530, US

(73) Assignee: Diehl AKO Stiftung & Co. KG, Wangen (DE)

(21) Appl. No.: 10/354,650

(22) Filed: Jan. 30, 2003

(30) Foreign Application Priority Data
Feb. 21, 2002 (DE) 102 07 232.9

(51) Int. Cl. H02P 1/54

(52) U.S. Cl. 318/110; 318/440

(57) ABSTRACT

In order to be able to operate variably and in particular in an optimised manner in a large domestic appliance not only the main drive (17) thereof but also the auxiliary drive (24) thereof, without having to substantially increase the overall control complication and expenditure of the appliance required for that purpose, the main and auxiliary drives (17, 24) are fed from the same dc voltage intermediate circuit (19) which is provided only once, by way of change-over switch sets (12), by half-bridge circuits (21, 21′). For that purpose it can be provided that the frequency converter (15) with its bridge circuit (21) for the main drive (17) is switched over in single-pole or multipole mode to the rotary field motor (23, 25) of the auxiliary drive (24) by way of a change-over switch set (12) connected in its output-side motor lines (13); or in the frequency converter (15) two half-bridge circuits (21, 21′) which are associated with the main and the auxiliary drives (17, 24) are operated in parallel from the dc voltage intermediate circuit (19). Such alternative circuit configurations, with the frequency converter (15) which in itself is designed for the main drive (17), by way of control of the rotary speed or the direction of rotation of the auxiliary drive (24), permit the implementation of additional flow-dependent functions such as for example flushing a washing machine pump free of washing threads and fibres caught therein.

The invention concerns a circuit arrangement as set forth in the classifying portion of claim 1.

In order to be able to adjust a rotary field which rotates independently of the fixed mains frequency and the mains voltage, for the operation of synchronous motors and asynchronous motors, it is usual to employ a circuit arrangement of the general kind set forth, in large domestic appliances, in particular for example for actuation of the drive motor for the washing drum in a washing machine or the circulating pump for the dishwashing agent circuit in a dishwashing machine, as the main drives thereof. In that situation the field coil of the respective motor is operated from the mains rectifier with a dc voltage intermediate circuit connected downstream thereof, by way of a frequency converter half-bridge arrangement which can be switched over in multipole mode. Rotary field control as a consequence of coordinated actuation of the switches in respect of repetition frequency, duration and mutual phase position is usually effected from a microprocessor in accordance with a program which is predetermined in accordance with the motor characteristic and on which present items of control and regulating information are superimposed in accordance with an operating program which is currently to be executed.

Besides such a main drive, a large domestic appliance is usually to be found to have an auxiliary drive of lower power, for additional functions which are only temporarily required, such as for example for filling or emptying the working chamber with an uninfluenced delivery, which for cost reasons is usually operated directly from the single-phase mains, without expensive rectifier control systems. This therefore involves accepting the fact that the mode of operation of the auxiliary drive cannot be optimised.

The object of the present invention is to make the use of auxiliary drives more flexible without an unreasonably high increase in technical complication and expenditure and thereby to optimise same from the operational point of view or even to be able to open therewith entirely new operating functions.

In accordance with the invention that object is attained in that, in accordance with the most important features recited in the main claim, the dc voltage intermediate circuit now provided at the mains for the feed to the frequency converter now supplies both the main drive and also an auxiliary drive. In that respect it can be provided that disposed in at least one of the motor feed lines from the frequency converter bridge circuit to the main drive there is a change-over switch which in this respect switches over the bridge circuit from the main drive and to the auxiliary drive. Then, instead of the previous main drive, the auxiliary drive is henceforth connected to the converter and can therefore be actuated without further additional complication and expenditure similarly to the main drive previously from the same frequency converter bridge circuit in order for example to vary the rotary speed thereof and under some circumstances also to provide a reversal in the direction of rotation. It is however also possible to operate the main and the auxiliary drive in parallel, possibly even at different speeds, insofar as two bridge circuits (one for each motor) are fed in parallel from the intermediate circuit.

This control use also for the auxiliary drive affords entirely new operational options such as a variation in or even a reversal in the direction of a delivery pressure which is produced by way of the auxiliary drive in order thereby to liberate for example sieves and filters but also the pump impeller itself quickly and effectively from washing fluff and similar impurities, which have become caught therein. In addition a reversal in flow which is produced by way of the pump, by means of water switching devices and similar pressure pulse switches in a pressure line downstream of the pump permits specifically controlled actuation of different functions of the appliance without intervention in the electrical operational control of the operating program. Particularly in this connection it is desirable for motor feed parameters of the frequency converter such as output voltage, current or electrical power to be evaluated as a measurement in respect of prevailing hydraulic or mechanical parameters in the system, for example in regard to the delivery pressure of a pump, in order to be able to register and possibly even correct the implementation of the function which is currently initiated.

Therefore, so that not only the main drive of a large domestic appliance but also the auxiliary drive thereof can be operated at any event variably and if possible even in an optimised fashion, without having to substantially increase the overall control complication and expenditure required for that purpose in the appliance, in accordance with the invention the dc voltage intermediate circuit which is present for the main drive is also made available for operation of the auxiliary drive. In particular a frequency converter which is fed from the intermediate circuit can be switched over in single-pole or multipole mode by way of a changeover switch set from the main drive to the rotary field motor of the auxiliary drive. That permits additional flow-dependent functions in the appliance such as for example flushing the pump free from washing threads and fibres which have been washed into the pump, with the frequency converter which is designed for the main drive, by way of control of the rotary speed or the direction of rotation of the auxiliary drive.

In regard to further particular operating options which are also afforded by virtue of a variable delivery pressure or a delivery direction, which can be switched over, of a pump driven by an electric motor, and which therefore can be particularly advantageously implemented with a switching-over motor control arrangement in accordance with the invention, attention is directed in terms of the full content thereof to the applicants' own earlier application DE 1 01 54 630.0 “electric-motor operated pump for a dishwashing machine” of Nov. 7, 2001, to supplement the disclosure of the present invention.

In regard to additional developments and further advantages of the invention reference is therefore made, besides the further claims, also to the description hereinafter of possible circuit configurations diagrammatically shown in the drawing in which:

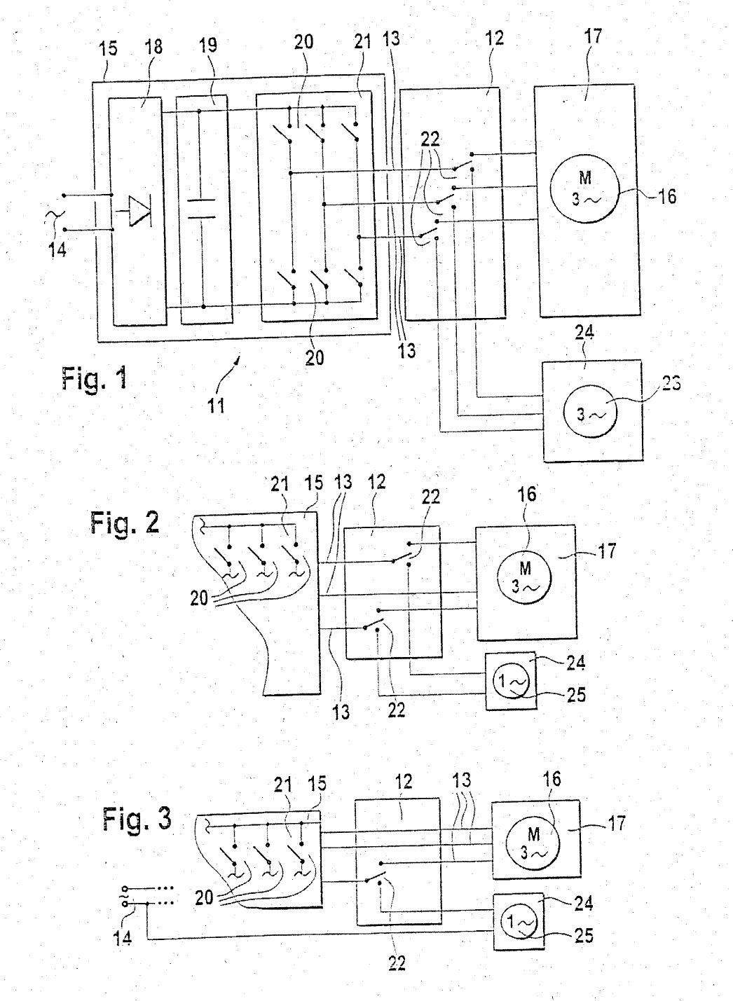

FIG. 1 shows a three-pole change-over switching arrangement in the motor feed lines at the output of a frequency converter in order to be able to change over from the operation of a main drive to the operation of an auxiliary drive with the same control options,

FIG. 2 shows a two-pole change-over switching arrangement for bringing into operation a single-pole auxiliary drive,

FIG. 3 shows a single-pole change-over switching arrangement for bringing into operation a single-pole auxiliary drive which is rotary field-synchronous with the feeding mains frequency,

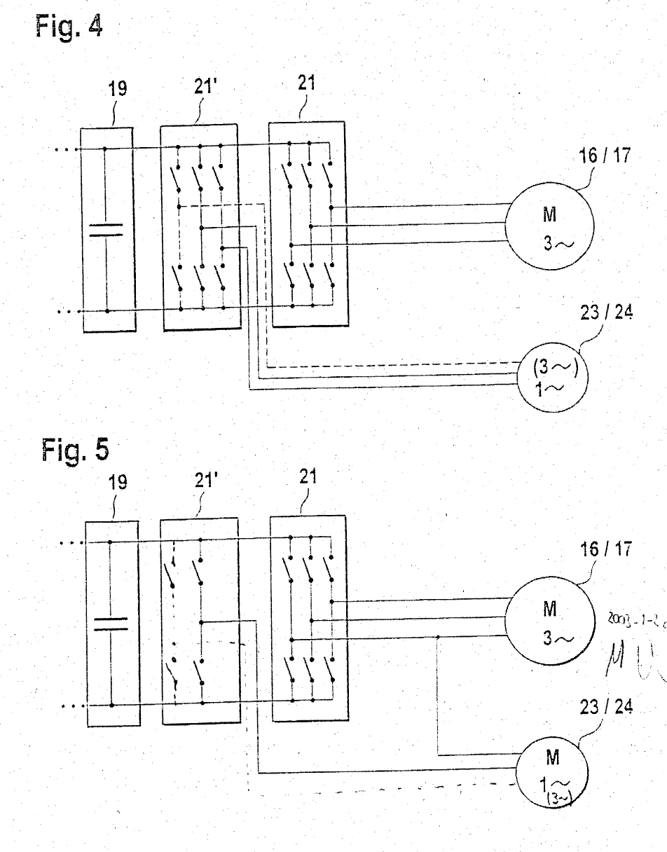

FIG. 4 shows a parallel operation of a three-phase main drive and a three-phase or single-phase auxiliary drive with separate bridge circuits downstream of a common dc voltage intermediate circuit, and

FIG. 5 as a modification in relation to FIG. 4 shows a possible way of providing for parallel operation of a three-phase main drive and a single-phase auxiliary drive with different rotary field frequencies.

The circuit arrangement 11 diagrammatically shown in FIG. 1 of the drawing substantially comprises a change-over switch set 12 in the three motor feed lines 13 from a frequency converter 15 fed from the domestic mains 14 to an asynchronous motor 16 or the like rotary field motor as the main drive 17 in a large domestic appliance (not shown), for example for driving the drum of a washing machine or the washing solution circulating pump of a dishwasher. In the frequency converter 15 a dc voltage intermediate circuit 19 which essentially comprises capacitors of high capacitance is charged up from a full-wave mains rectifier 18 in a Graetz circuit. The output voltage of the intermediate circuit 19 is connected to the three motor feed lines 13 to the main drive 17 by way of pairs, which are alternately switched on, of switching sections 20 of a triple half-bridge circuit 21 of alternate polarities and variable durations. Control of the switching procedures in the frequency converter 15 by way of a programmed processor is omitted from the drawing for the sake of enhanced clarity thereof, especially as those features in that respect form part of the state of the art.

In the case shown in FIG. 1 the output of the inverter bridge circuit 21 in the frequency converter 15 is switched by the change-over switch set 12 arranged in accordance with the invention in the motor feed lines 13, with in this case by way of example three change-over switches 22, from the three-phase motor 16 of the main drive 17 to an asynchronous or synchronous rotary field motor 23, which in this case is also a three-phase motor, of an auxiliary drive 24. That change-over switching procedure causes the main drive 17 to be taken out of operation and the auxiliary drive 24 to be brought into operation in order for example to change over from driving a washing drum to driving an emptying pump. Motor control for the auxiliary drive 24, without in this respect requiring additional circuitry measures, is effected, like that of the main drive 17, from the same frequency converter 15, now under the influence of a control program designed for operation of the auxiliary drive 24. In particular, as in regard to the main drive 17, it is also possible in regard to the auxiliary drive 24 to infer from its feed parameters which are currently measured on the motor feed lines 13 (voltages and currents, or the product thereof as electrical power draw) current mechanical or hydraulic loadings in the fluid system, and in accordance therewith operation of the auxiliary drive 24 can be influenced and in particular optimised both in regard to its power consumption and also in regard to its effect.

In the circuitry modification shown in FIG. 2 the change-over switch set 12 in the motor feed lines 13 comprises only two change-over switches 22 for switching over from the main drive 17 to an auxiliary drive 24 with for example a single-phase synchronous or the like rotary field motor 25 which can also involve a capacitor asynchronous motor. Like the main drive 17 previously, this auxiliary drive 24 can also be fed by way of the rectifier bridge circuit 21 which is provided alone downstream of the intermediate circuit 19, with a variable-frequency rotary field for example in order to cause it to start generally and to vary the operating speed of rotation.

In the modification shown in FIG. 3 the change-over switch set 12, in comparison with FIG. 1 or FIG. 2, only has one change-over switch 22 so that now it is only possible to switch over one of the motor feed lines 13 from the main drive 17 to the auxiliary drive 24, while the second feed line thereof is fixedly connected to a pole of the single-phase mains feed voltage 14. The inverter bridge circuit 21 which is designed primarily for control of the main drive 17 thus again also serves for actuation of a single-phase motor 25; that minimised topology with its reduced change-over switch set 12 is at any event still suitable for control in respect of voltage and direction of rotation of the synchronous motor 25 in the auxiliary drive 24 if it is operated in the steady-state condition at the frequency of the domestic mains 14. The limited rotary speed control of a capacitor asynchronous motor can also be implemented here.

In the configuration shown in FIG. 4 in contrast the arrangement entirely eliminates switching over between the main and the auxiliary drives 18-24. Rather, in this case the dc voltage intermediate circuit 19 in the frequency converter 15, in parallel with the half-bridge circuit 21 for the main drive 18, feeds a further half-bridge circuit 21′ for a single-phase auxiliary drive 23. The broken-line addition expresses the fact however that this may also be a three-phase auxiliary drive 23.

A topology as shown in FIG. 5 finally permits parallel operation of the main and the auxiliary drives 18/23, even at a differing, frequency, that is to say also with a rotary field rotating at a different speed. The only condition is that the sum of the two motor voltages (16+23) does not exceed the dc voltage at the output of the intermediate circuit 19. Because for example the drum main drive of a washing machine is fed with low motor voltage over relatively long periods of time for a low speed of rotation for washing, in the meantime a sufficient voltage reserve is available for simultaneous operation of an auxiliary drive.

1. A circuit arrangement (1) for the actuation of an electric-motor main drive (17) operated from a frequency converter (15) with a controlled bridge circuit (21) in a large domestic appliance which is also equipped with an auxiliary drive (24), characterised in that the auxiliary drive (24) is fed from the same dc voltage intermediate circuit (19) as the main drive (17).

2. A circuit arrangement according to claim 1 characterised in that the bridge circuit (21) can be switched over from the main drive (17) to the auxiliary drive (24) by way of a change-over switch set (12), whereupon the auxiliary drive (24) is actuable from the frequency converter (15) which in itself is designed for the main drive (17).

3. A circuit arrangement according to claim 2 characterised in that in each of the three motor feed lines (13) the change-over switch set (12) has a change-over switch (22) for switching over to a three-phase rotary field motor (23) in the auxiliary drive (24).

4. A circuit arrangement according to claim 2 characterised in that the change-over switch set (12) has two change-over switches (22) for switching over from operation of the main drive (17) to an auxiliary drive (24) with a single-phase rotary field motor (25).

5. A circuit arrangement according to claim 2 characterised in that the change-over switch set (12) has a change-over switch (22) in one of the three motor feed lines (13) for switching over the operation from the main drive (17) to an auxiliary drive (24) with a single-phase motor (25) whose second motor line is fixedly connected to a pole of the feeding mains (14) upstream of the frequency converter (15).

6. A circuit arrangement according to claim 1 characterised in that two half-bridge circuits (21, 21′) are fed in parallel from the dc voltage intermediate circuit (19), which bridge circuits are associated with the main drive (17) and he auxiliary drive (24) respectively.

7. A circuit arrangement according to claim 6 characterised in that the auxiliary drive (24) with a single-phase or three-phase motor (23) is connected to a three-phase or two-phase half-bridge circuit (21′) respectively.

8. A circuit arrangement according to claim 6 characterised in that for parallel operation of main and auxiliary drives (17, 24) at different rotary field frequencies the auxiliary drive (24) with a two-phase motor (23) is connected in single-phase relationship to an arm of the bridge circuit (21) for the main drive (17) and with the other phase to the single arm of a bridge circuit (21′), operated in parallel therewith, for the auxiliary drive (24), wherein the motors (16, 23) for the main and auxiliary drives (17, 24) are so designed that the sum of their two motor voltages does not exceed the intermediate circuit voltage at the output of the dc voltage intermediate circuit (19).
